(19) United States
(12) Patent Application Publication
(10) Pub. No.: US 2003/0209962 A1
(43) Pub. Date: Nov. 13, 2003

(54) Incandescent lamp for use in high efficiency illumination systems

(76) Inventors: Andrew Davies, Hinckley (GB); Roger Alan Hume, Melton Mowbray (GB)

Correspondence Address: John F. Beninati, General Electric Company, 3135 Easton Turnpike, W3C, Fairfield, CT, 06431, US

(21) Appl. No.: 09/852,477

(22) Filed: May 10, 2001

(51) Int. Cl. H01K 1/18

(52) U.S. Cl. 313/272; 313/115

(57) ABSTRACT

An incandescent lamp comprises at least four linear, helically-wound filament sections arranged with their longitudinal axes substantially parallel with each other and including a first filament section located along the longitudinal axis of the lamp with the remaining filament sections arranged substantially symmetrically around the first filament section.

This invention relates generally to an incandescent lamp for use in high efficiency illumination systems, and more particularly but not exclusively to incandescent lamps for use in combination with a concave reflector in collecting a high proportion of the emitted light and projecting a high-intensity beam with a smooth distribution of light.

Incandescent lamps of this kind are typically used in theatre, film, television, architectural and other general purpose lighting fixtures that provide high-intensity beams of light. It is desirable in such fixtures to collect as much of the light emitted by the lamp as possible, and project that light forward in a high-intensity beam.

A term used to describe the proportion of light projected into the beam is “luminaire efficiency” which is defined as the ratio of a luminaire's total light output to the light emitted by the lamp expressed as a percentage or as a decimal; fraction.

Increasing the luminaire efficiency will have the benefit of improving the luminaire efficacy which is defined as the quantity of light (lumens) in the beam per unit of power (Watts) consumed by the system.

Furthermore, it is desirable in many applications for the distribution of light within the beam to be symmetrical through 360 degrees. It is also desirable in many applications for the light within the beam to be smoothly distributed across the entire beam.

One commercial embodiment of a system of this type, known commercially as the “Source Four” system, is described in U.S. Pat. No. 5,268,613. In this system, a high intensity beam is generated using a filament with a multiplicity of helically-wound coils arranged in a substantially symmetrical pattern around the longitudinal axis of the lamp. This system has been shown to deliver improved luminaire efficacies compared to more traditional illumination systems. The symmetrical arrangement of the filament sections has also provided improved, smoother, more symmetrical beams than was the case with other systems. However, it is believed that there is still considerable scope for further improvement in luminaire efficiency, field smoothness and beam symmetry.

It is well known to those skilled in the art that the efficacy (lumens per watt) of an incandescent lamp may be improved by means of an infra-red reflective coating on the outer glass or quartz bulb of the lamp. The coating reflects the infra-red radiation emitted back to the filament, which returns energy to the filament and means that less power is required to be supplied to the lamp in order to achieve the desired light output. Lamps utilising this technology are commercially available for display and automotive applications, but none of the commercial lamps used in the illumination systems described herein use the technology. In particular, the filament design used in the “Source Four” system is considered unsuitable for this technology, since the large gaps between the filament sections mean that a substantial proportion of the reflected infra-red radiation is not collected by the filament.

It will be understood that there is a need for a lamp which provides the combined benefits of increased luminaire efficacy, improved field smoothness and improved beam symmetry. In particular there is a need for a lamp with a filament structure which delivers these benefits whilst being at the same time suitable for use in lamps employing infra-red reflecting coatings for further improvements in efficiency. The invention described herein achieves all of these objectives.

According to the invention, an incandescent lamp comprises at least four linear, helically-wound filament sections arranged with their longitudinal axes substantially parallel with each other and including a first filament section located along the longitudinal axis of the lamp with the remaining filament sections arranged substantially symmetrically around the first filament section.

The lamp suitably has 4, 5 or 6 filament sections but mat have more than 6 if desired

Preferably the filament sections are connected in series but, if desired, combinations of the filament sections are connected in parallel and these parallel connected combinations may be connected in series.

Suitably, the filament sections may be arranged such that the spacing between them is as small as possible without causing a significant risk of arcing and this may be assisted by the use of hydrogen gas within the lamp.

The lamp may comprise a glass or quartz bulb coated with a material which is capable of reflecting infra-red radiation back to the filament structure. Such a coating may comprise a multiplicity of layers and these layers may comprise tantalum oxide and silicon oxide. A suitable coating may comprises 56 layers.

The invention will now be described in greater detail, by way of example, with reference to the drawings, in which:—

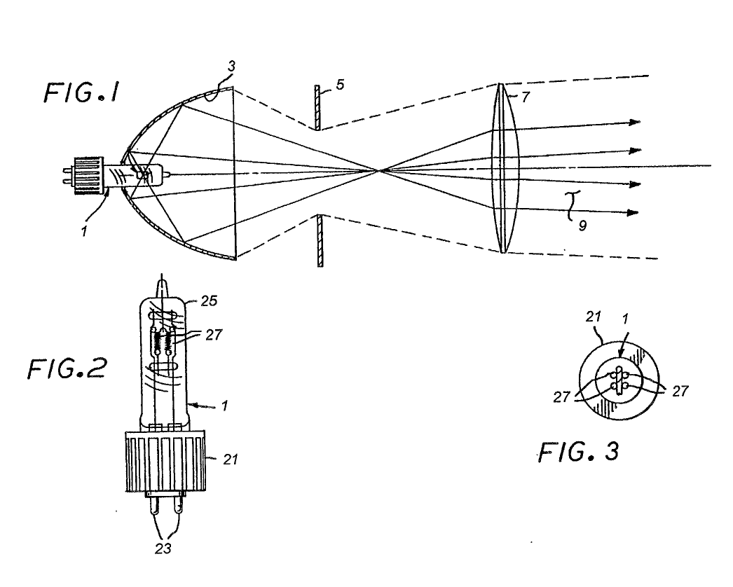

FIG. 1 is a schematic view of a known lamp system such as is disclosed in U.S. Pat. No. 5,268,613;

FIG. 2 is a schematic side view of a known lamp having four filament sections suitable for use in the system of FIG. 1;

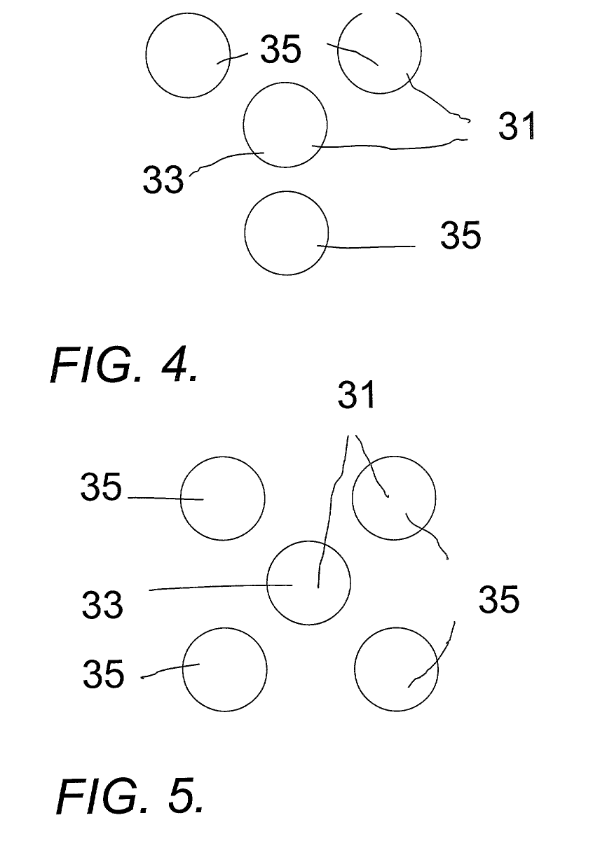

FIG. 3 is a plan view of the lamp of FIG. 2;

FIG. 4 depicts the arrangement of the filament sections in the case of a four-filament lamp in accordance with the invention;

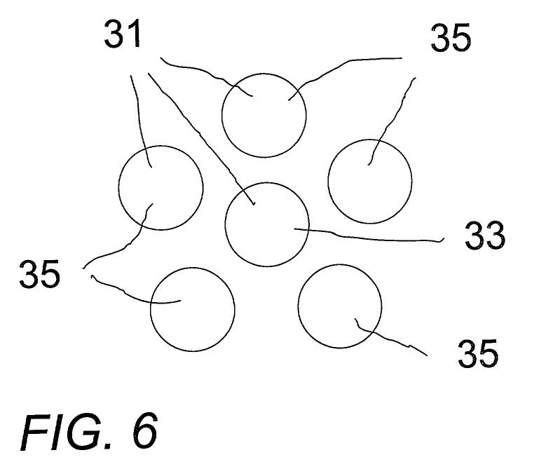

FIG. 5 depicts the arrangement of the filament sections in the case of a five-filament lamp in accordance with the invention, and

FIG. 6 depicts the arrangement of the filament sections in the case of a six-filament lamp in accordance with the invention.

Referring firstly to FIGS. 1 to 3, there is shown a typical set up for a high efficiency illumination system. Thus the system comprises an incandescent lamp 1, a concave reflector 3, an aperture 5 and a lens 7. This system provides for a concentrated beam of light 9.

The incandescent lamp used with this system is shown in FIGS. 2 and 3 and comprises a base 21 with connectors 23 and a glass or quartz bulb 25. Inside the bulb are arranged four filament sections 27 which are arranged in two offset rows of two filament sections.

In order to improve the output of this type of lamp, the invention proposes a different arrangement of the filaments of the lamp as can be seen in FIGS. 4 to 6 in schematic plan view. The remainder of the lamps is omitted for clarity

In all of these embodiments it will be seen that the lamp comprises at least three linear, helically-wound filament sections 31 arranged with their longitudinal axes substantially parallel with each other. A first filament section 33 is located along the longitudinal axis of the lamp while the remaining filament sections 35 are arranged substantially symmetrically around the first filament section 33

In the first embodiment shown in FIG. 4, there is the one central section 33 with the remaining three sections 35 arranged in a substantially triangular pattern equidistant from the central section.

In the second embodiment shown in FIG. 5, there is the one central section 33 with the remaining four sections 35 arranged in a substantially square pattern equidistant from the central section.

In the third embodiment shown in FIG. 6, there is the one central section 33 with the remaining five sections 35 arranged in a substantially pentagonal pattern equidistant from the central section.

It will be appreciated that more than six filament sections may be used if desired.

In order to make the best use of the new configurations, it is desirable that the glass or quartz bulbs of the lamps be coated with a material which is capable of reflecting infra-red radiation back to the filament structure. Such a coating may comprise a multiplicity of layers and these layers may comprise tantalum oxide and silicon oxide. A suitable coating may comprise 56 layers.

With the layout of the filaments in accordance with the invention, more of the infra red radiation will be received by the filaments than in the usual configuration thereof making the lamps in accordance with the invention more efficient.

1. An incandescent lamp comprising at least four linear, helically-wound filament sections arranged with their longitudinal axes substantially parallel with each other and including a first filament section located along the longitudinal axis of the lamp with the remaining filament sections arranged substantially symmetrically around the first filament section.

2 A lamp as claimed in claim 1 wherein the total number of filament sections is 5.

3. A lamp as claimed in claim 1 wherein the total number of filament sections is 6.

4. A lamp as claimed in claim 1 wherein the total number of filament sections is greater than 6.

5. A lamp as claimed in claim 1 wherein the filament sections are connected in series.

6. A lamp as claimed in claim 1 wherein combinations of the filament sections are connected in parallel.

7. A lamp as claimed in claim 6 wherein the parallel connected combinations are connected in series.

8. A lamp as claimed in claim 1 wherein the filament sections are arranged such that the spacing between them is as small as possible without causing a significant risk of arcing.

9. A lamp as claimed in claim 1 wherein the gas inside the lamp comprises hydrogen.

10. A lamp as claimed in claim 1 wherein the lamp comprises a glass or quartz bulb coated with a material which is capable of reflecting infra-red radiation back to the filament structure.

11. A lamp as claimed in claim 10 wherein the coating comprises a multiplicity of layers.

12. A lamp as claimed in claim 11 wherein the coating comprises tantalum oxide and silicon oxide.

13. A lamp as claimed in claim 12 wherein the coating comprises 56 layers.

14. An illumination arrangement comprises a lamp as claimed in claim 1 arranged axially in a concave reflector.
